(19) United States
(12) Patent Application Publication
(10) Pub. No.: US 2026/0154868 A1
(43) Pub. Date: Jun. 4, 2026

(54) METHOD FOR GENERATING AN ELECTRONIC ROAD MAP WITH CLASSIFICATION INFORMATION AND ROAD MAP

(71) Applicant: Robert Bosch GmbH, Stuttgart (DE)

(72) Inventors: Bogdan-Alexandru Kandra, Cluj-Napoca (RO); Mihai Barbulescu, Cluj-Napoca (RO)

(21) Appl. No.: 19/389,883

(22) Filed: Nov. 14, 2025

(30) Foreign Application Priority Data
Nov. 29, 2024 (DE) 10 2024 211 442.1

(51) Int. Cl. G06T 11/20; G01C 21/00; G06V 10/764; G06V 10/82

(52) U.S. Cl. CPC G06T 11/23; G01C 21/3822; G01C 21/3844; G06V 10/764; G06V 10/82

(57) ABSTRACT

A method for generating an electronic road map with classification information for a traffic junction. The method includes: receiving position information of a spatial region of an electronic road map that includes a traffic junction; receiving position data from a plurality of vehicles driving through the traffic junctions; classifying the traffic junction using a classifier module based on the position information of the spatial region that includes the traffic junction and based on the position data from the vehicles driving through the traffic junction. The classifying includes identifying the traffic junction as a roundabout if at least a predefined number of position histories in the plurality of position histories exhibit a predefined curve profile. The method further includes adding classification information for the traffic junction to the electronic road map and generating the electronic road map with classification information.

### CROSS REFERENCE

The present application claims the benefit under 35 U.S.C. § 119 of Germany Patent Application No. DE 10 2024 211 442.1 filed on Nov. 29, 2024, which is expressly incorporated herein by reference in its entirety.

### FIELD

The present invention relates to a method for generating an electronic road map with classification information for a traffic junction and an electronic road map. The present invention also relates to a method for generating a training data set for training a classifier module for classifying traffic junctions and a corresponding training data set.

### BACKGROUND INFORMATION

Certain electronic road maps are described in the related art. To use these road maps to assist in vehicle control, it is important to be able to distinguish different traffic junctions from one another.

### SUMMARY

It is an object of the present invention to provide an improved method for generating an electronic road map with classification information for a traffic junction, an electronic road map, a method for generating a training data set for training a classifier module for classifying traffic junctions and a training data set.

This object may be achieved by the methods, the road map, and the training data set of the present invention. Advantageous embodiments of the present invention are disclosed herein.

According to one aspect of the present invention, a method for generating an electronic road map with classification information for a traffic junction is provided. According to an example embodiment of the present invention, the method comprises:
receiving position information of a spatial region of an electronic road map that includes a traffic junction;
receiving position data from a plurality of vehicles driving through the traffic junctions, wherein the position data depict position histories of the vehicles as they drove through the traffic junction;
classifying the traffic junction by means of a classifier module based on the position information of the spatial region that includes the traffic junction and based on the position data from the vehicles driving through the traffic junction, wherein classifying comprises:
identifying the traffic junction as a roundabout if at least a predefined number of position histories in the plurality of position histories exhibit a predefined curve profile,
adding classification information for the traffic junction to the electronic road map and generating the electronic road map with classification information.

This makes it possible to achieve a technical advantage that an improved method for generating an electronic road map with classification information for a traffic junction can be provided. This involves making position information for a spatial region in which a traffic junction is shown in the electronic road map available in an existing electronic road map that does not contain classifications of the traffic junctions included in it.

Also provided are position data from a plurality of vehicles that drove through the traffic junction shown in the electronic road map at an earlier point in time. The position data describe position histories of the vehicles as they drove through the traffic junction.

The position information from the electronic road map and the position data from the plurality of vehicles, are then used by a correspondingly trained classification module to carry out a classification of the respective traffic junction.

The respective traffic junction is identified as a roundabout if a predefined number of position histories of the plurality of position histories of the vehicles exhibit a predefined curve profile.

The corresponding classification information, in which the respective traffic junction has been classified as a roundabout, is then added to the electronic road map and used to generate an electronic road map with classification information. The correspondingly generated electronic road map with classification information is an improved road map, because the added classification information for the traffic junction provides important additional information for assisting in the control of a vehicle.

The driving behavior of other road users can be inferred depending on the configuration of the respective traffic junction to be driven. This enables improved control of the vehicle taking into account the generated electronic road map with classification information for the traffic junction.

According to one example embodiment of the present invention, classifying comprises:
identifying the traffic junction as one from the following list: intersection, junction, on-ramp onto a country road, federal highway or freeway, off-ramp from a country road, federal highway or freeway, highway interchange, if less than the predefined number of position histories in the plurality of position histories exhibit the predefined curve profile.

This makes it possible to achieve a technical advantage that, in addition to roundabouts, other types of traffic junctions, such as intersections or on-ramps and off-ramps, can be classified by the classifier module and corresponding classification information can be incorporated into the electronic road map.

Taking into account the predefined curve profile enables a precise distinction between a roundabout and, for example, a junction configured as an intersection based on the position histories of the trips of the vehicles through the respective traffic junctions.

According to one example embodiment of the present invention, the predefined curve profile has a profile from the following list: quarter-circular profile, semicircular profile, three-quarter circular profile, circular profile.

This makes it possible to achieve a technical advantage that the corresponding configuration of the predefined curve profile as a quarter-circular profile, semicircular profile, three-quarter circular profile or circular profile enables a clear distinction between traffic junctions configured as roundabouts and traffic junctions configured as intersections or on-ramps or off-ramps.

According to one example embodiment of the present invention, the predefined curve profile includes a predefined angular range, wherein the predefined angular range is an angle from the following list: at least 90°, at least 180°, at least 270°, at least 360°.

This makes it possible to achieve a technical advantage that taking into account the angular range of the predefined curve profile again enables a clear and precise classification of the traffic junction. It is in particular possible to precisely distinguish a roundabout from a traffic junction configured, for instance, as an intersection.

According to one example embodiment of the present invention, the predefined curve profile has a predefined curve radius.

This makes it possible to achieve the technical advantage that taking into account the curve radius of the predefined curve profile again enables a clear classification of the traffic junction and a clear distinction between a roundabout and a traffic junction configured, for instance, as an intersection.

According to one example embodiment of the present invention, classifying further comprises:
generating an image representation of the traffic junction with the position histories of the vehicles passing through it based on the position information of the spatial region of the traffic junction and the position data of the vehicles, wherein identifying comprises:
recognizing the predefined curve profile in the position histories of the vehicles.

This makes it possible to achieve the technical advantage that it enables precise classification of the traffic junction by the classifier module. For this purpose, image representations of the traffic junction of the road map and the position histories of the vehicles that drove through the respective traffic junction at an earlier point in time are generated.

Based on the image representations generated in this way, the classifier module can classify the traffic junction by recognizing the corresponding curve profiles of the position histories of the vehicles through the traffic junction. To recognize the predefined curve profiles within the position histories of the vehicles in the image representations, the classifier module can, for example, use object recognition.

According to one example embodiment of the present invention, generating the image representation comprises:
carrying out a mapping of the position data of the position histories of the vehicles to the position information of the spatial region of the traffic junction by selecting the position information of the spatial region that corresponds to the position data of the respective position histories of the vehicles;
generating vector representations of the selected position information of the spatial region of the traffic junction;
rasterizing the vector representations by mapping the selected position information of the spatial region of the traffic junction that represents the position histories as contiguous line elements on a predefined image surface wherein recognizing the curve profiles comprises:
converting the image representation into tensor representations.
This makes it possible to achieve the technical advantage that it enables further improvement of the classification of the traffic junction by the classifier module.

The image representations are achieved by ascertaining position information in the position information of the spatial region of the respective traffic junction in the electronic road map that corresponds to the position data of the position histories of the vehicles that represent the trips of the vehicles through the traffic junction. The correspondingly selected position information is then displayed in a predefined image surface as contiguous line elements.

The correspondingly generated image representations thus primarily comprise the contiguous line elements of the position histories of the vehicles through the traffic junction, which facilitates the recognition of the curve profiles within the position histories by the classifier module. To carry out the recognition of the curve profiles by the classifier module, the image representations are further converted into tensor representations, on which the object recognition for recognizing the curve profiles is ultimately carried out.

This enables the most precise possible recognition of the curve profiles and, based on this, a correspondingly precise classification of the traffic junctions.

According to one example embodiment of the present invention, the tensor representations are embodied as grayscale tensor representations.

This makes it possible to achieve a technical advantage that the embodiment of the tensor representations as grayscale tensor representations provides the simplest possible representation for object recognition. This can further improve the precision of object recognition.

According to one example embodiment of the present invention, the spatial region of the traffic junction of the electronic road map is shaped as a polygon and represents a spatial outline of road boundaries of roads converging at the traffic junction.

This makes it possible to achieve a technical advantage that the spatial region of the electronic road map that includes the traffic junction can be used to provide a precise depiction of the traffic junction and in particular the relevant features of the traffic junction.

According to one example embodiment of the present invention, the classifier module comprises at least one correspondingly trained convolutional neural network.

This makes it possible to achieve the technical advantage that the correspondingly trained convolutional neural network enables precise object recognition based on the image representations of the position histories of the vehicles through the traffic junction and, based on this, precise recognition of the curve profiles of the position histories.

According to one example embodiment of the present invention, the position data of the vehicles are GPS trace data.

This makes it possible to achieve a technical advantage that the GPS trace data of the vehicles can be used to provide precise position data and thus precise position histories of the vehicles through the traffic junction.

According to one aspect of the present invention, an electronic road map with classification information for a traffic junction is provided, wherein the road map was generated according to the method for training a classifier module for classifying a traffic junction according to one of the above-described embodiments of the present invention.

According to one aspect of the present invention, a method for generating a training data set for training a classifier module to carry out a classification of a traffic junction for generating an electronic road map with classification information according to one of the above-described embodiments is provided. According to an example embodiment of the present invention, the method comprises:
receiving position information of a spatial region of an electronic road map that includes a traffic junction;
receiving position data from a plurality of vehicles driving through the traffic junction, wherein the position data depict position histories of the vehicles as they drove through the traffic junction;
carrying out a mapping of the position data of the position histories of the vehicles to the position information of the spatial region of the traffic junction by selecting the position information of the spatial region that corresponds to the position data of the respective position histories of the vehicles;
generating vector representations of the selected position information of the spatial region of the traffic junction;
rasterizing the vector representations by mapping the selected position information of the spatial region of the traffic junction that represents the position histories as contiguous line elements on a predefined image surface,
generating tensor data based on the image representation, and
aggregating the tensor data into the training data set.

This makes it possible to achieve a technical advantage that an improved method for generating a training data set can be provided.

According to one aspect of the present invention, a training data set for training a classifier module for classifying a traffic junction is provided, wherein the training data set was generated according to the method for generating a training data set, according to the present invention.

This makes it possible to achieve a technical advantage that it provides an improved training data set that enables improved training of a classifier module for classifying traffic junctions.

According to one aspect of the present invention, a computing unit is provided that is configured to execute the method for generating an electronic road map according to one of the above-described embodiments and/or the method for generating a training data set for training a classifier module for classifying a traffic junction, according to example embodiments of the present invention.

According to one aspect of the present invention, a computer program product is provided, which comprises instructions that, when the program is executed by a data processing unit, cause said data processing unit to carry out the method for generating an electronic road map according to one of the above-described embodiments and/or the method for generating a training data set for training a classifier module for classifying a traffic junction, according to example embodiments of the present invention.

Example embodiments of the present invention are described with reference to the figures.

### BRIEF DESCRIPTION OF THE DRAWINGS

FIG. 1 (including diagrams a) and b)) shows a schematic illustration of method steps of a method for generating an electronic road map with classification information for a traffic junction according to one example embodiment of the present invention.

FIG. 2 shows a further schematic illustration of method steps of the method for generating an electronic road map with classification information for a traffic junction according to another example embodiment of the present invention.

FIG. 3 shows a schematic illustration of method steps of a method for generating a training data set for training a classifier module for classifying a traffic junction according to one example embodiment of the present invention.

FIG. 4 shows a flow chart of the method for generating an electronic road map with classification information for a traffic junction according to one example embodiment of the present invention.

FIG. 5 shows a further flow chart of the method for generating an electronic road map with classification information for a traffic junction according to another example embodiment of the present invention.

FIG. 6 shows a further flow chart of the method for generating an electronic road map with classification information for a traffic junction according to another example embodiment of the present invention.

FIG. 7 shows a further flow chart of the method for generating a training data set for training a classifier module for classifying a traffic junction according to one example embodiment of the present invention.

FIG. 8 shows a schematic illustration of a computer program product, according to an example embodiment of the present invention.

### DETAILED DESCRIPTION OF EXAMPLE EMBODIMENTS

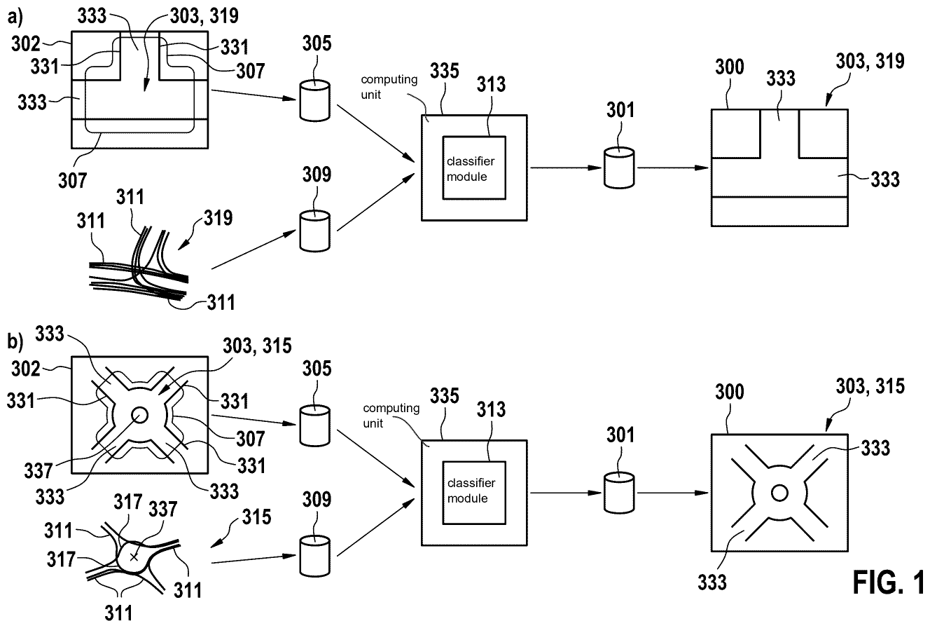

FIG. 1 shows a schematic illustration of method steps of a method 100 for generating an electronic road map 300 with classification information 301 for a traffic junction 303 according to one embodiment.

The diagrams a) and b) of FIG. 1 show different steps of the method 100 according to the present invention for generating an electronic road map 300 with classification information 301 for a traffic junction 303 for two different examples of a traffic junction 303.

Diagram a) shows a traffic junction 303 configured as an intersection 319. Diagram b), on the other hand, shows a traffic junction 303 configured as a roundabout 315.

To classify the traffic junction 303 of the electronic road map 302, first the position information 305 of the spatial region 307 of the traffic junction 303 of the electronic road map 302 is received.

In the shown embodiments, the spatial region 307 is depicted as a polygon that depicts the perimeter of the road boundaries 331 of the roads 333 of the traffic junction 303. The shape of the spatial region 305 can vary depending on the configuration of the respective traffic junction 303, as shown in the two map representations 302 of diagrams a) and b).

The position data 309 of the position histories 311 of the vehicles that drove through the respective traffic junction 303 at an earlier time are received as well.

The position data 309 can be GPS trace data of the vehicles, for example. The position data 309 can in particular be fleet data from a plurality of vehicles that have passed through the respective traffic junction 303 at different times.

The classifier module 313 executed on the depicted computing unit 335 uses the position information 305 from the map representation 302 and the position data 309 of the plurality of vehicles to carry out the classification of the traffic junction 303.

For this purpose, the classifier module 313 identifies the respective traffic junction 303 as a roundabout 315 if a predefined number of position histories 311 among the plurality of position histories 311 of the plurality of vehicles exhibit a predefined curve profile 317.

The predefined curve profile can be defined by the shape of the curve profile, for example. For this purpose, the predefined curve profile 317 can, for example, be defined as at least a quarter-circular profile, a semicircular profile, a three-quarter circular profile or a fully circular profile.

Alternatively or additionally, the predefined curve profile 317, which must be depicted in the position histories 311 of the vehicles in the region of the traffic junction 303 so that the respective traffic junction 303 is classified as a roundabout 315, can be defined by a predefined angular range enclosed by the respective curve region.

The predefined curve profile 317 can include at least an angle of 90°, at least an angle of 180°, at least an angle of 270°or at least an angle of 360°, for instance.

Alternatively or additionally, the predefined curve profile 317 can be defined via a predefined curve radius.

The corresponding definition criteria used to define the predefined curve profile 317 allow the respective traffic junction 303 to be identified as a roundabout 315 based on the position histories 311 of the vehicles that have driven through the respective traffic junction 303.

As shown in the position histories 311 of diagram b), the circular configuration of the roundabout 315 results in a plurality of position histories 311 in the region of the traffic junction 303 that likewise exhibit a nearly circular curve profile 317.

Other traffic junctions 303, such as the intersection 319 shown in diagram a), do not exhibit such circular position histories 311 of the vehicles driving through the traffic junction 303 due to the corresponding road layout within the traffic junction 303.

Based on the circular profile, for example quarter-circular, semicircular, three-quarter circular or fully circular, and/or based on the included angular range, for example at least 90°, at least 180°, at least 270°or at least 360°, and/or based on the respective curve radius of the predefined curve profile 317, the more detailed position histories 311 of the vehicles can be used to carry out a corresponding classification of the respective traffic junction 303.

After the traffic junction 303 to be classified has been classified by the classifier module, corresponding classification information 301 is provided, in which the respective traffic junction 303 is classified as a roundabout 315 or as an intersection 319, for example, and is inserted into the road map 302 as additional information. Thus, the corresponding road map 302 to be generated is generated with the classification information 301 for a traffic junction 303.

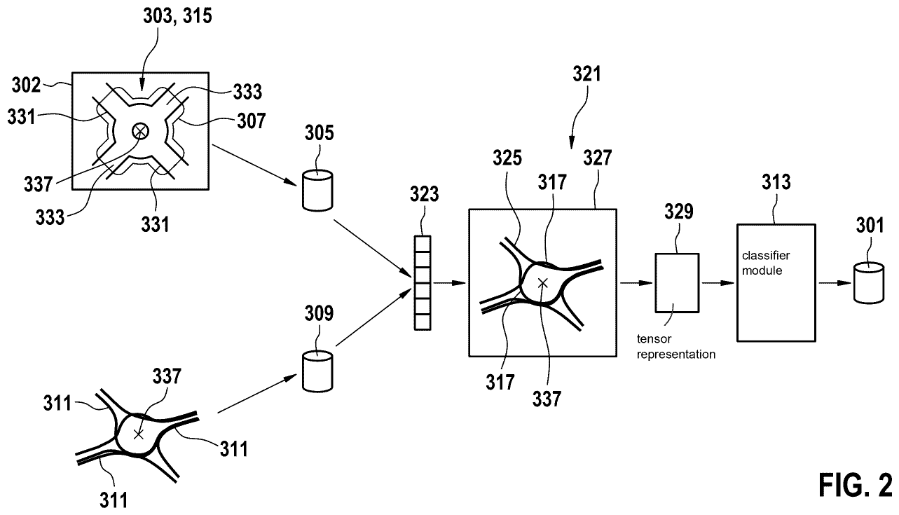

FIG. 2 shows a further schematic illustration of method steps of the method 100 for generating an electronic road map 300 with classification information 301 for a traffic junction 303 according to another embodiment.

The embodiment shown in FIG. 2 is based on the embodiment in FIG. 1 and comprises the method steps described there. For the sake of simplicity, the present embodiment is described only for the example of diagram b) in FIG. 1, in which the traffic junction 303 is configured as a roundabout 315.

First, a feature extraction is carried out based on the position information 305 of the road map 302 and the position data 309 of the vehicles.

This is used to generate a vector representation 323 of the information of the position information 305 of the map representation 302 and the position data 309 of the vehicles.

Based on this, an image representation 321 of the traffic junction is generated by carrying out a rasterization of the vector representations.

To generate the image representation 321, the position data 309 of the vehicles are first mapped to the position information 305 of the spatial region 307 of the traffic junction 303 of the road map 302.

This involves ascertaining the position information of the road map 302 in the region of the traffic junction 303 which corresponds to the position data 309 of the position histories 311 of the vehicles as they drive through the respective traffic junction 303.

The position information selected in this way thus corresponds to a mapping of the position data of the position histories 311 of the vehicles to the spatial region 307 of the traffic junction 303 of the road map 302.

To generate the image representation 321, the correspondingly selected position information 305 of the map representation 302, which corresponds to the position data 309 of the position histories 311 of the vehicles, is depicted as contiguous line elements 325 on a predefined image surface 327.

The image representation 321 generated in this way thus comprises the predefined image surface 327, which primarily or exclusively shows the position histories 311 of the vehicles as they drove through the traffic junction 303 depicted as contiguous line elements 325.

As can be seen from FIG. 2, the corresponding contiguous line elements 325 of the position histories 311 exhibit the nearly circular predefined curve profiles 317 disposed around the center 337 of the depicted roundabout 315.

To carry out object recognition for identifying the predefined curve profiles 317 from the image representations 321, in the shown embodiment, a tensor representation 329 is generated from the correspondingly generated image representation 321.

According to one embodiment, the tensor representation can be configured as a grayscale tensor representation.

Executing the classifier module 313 on the tensor representation 329 enables the classifier module 313 to identify the predefined curve profiles 317 from the contiguous line elements 325 generated based on the position histories 311 of the vehicles and, based on this, classify the traffic junction 303.

According to the embodiment in FIG. 1, corresponding classification information 301 is then generated.

According to one embodiment, the classifier module 313 comprises a correspondingly trained convolutional neural network which is configured to identify the predefined curve profile 317 based on the described image representations 321 and with it classify the respective traffic junction 303 as a roundabout 315 or as one from the following list: an intersection 319, a junction, an on-ramp onto a country road, a federal highway or freeway, an off-ramp from a country road, a federal highway or freeway, or a highway interchange.

According to one embodiment, the convolutional neural network comprises a VGG architecture with four convolutional blocks and a decoder block. The convolutional blocks are sequential layers that each comprise a convolutional layer with ReLu activation, max pooling and dropout layers. In the dropout layers, the probability can be set to 0.2, for example.

In the last convolutional block, the probability can be set to 0.3. In the decoder block, the probability can be set to 0.5.

The kernel size of the convolutional layers can be set to 3, while the kernel size of the max pooling layers is set to 2, so that the kernel has the same dimensions as the feature map.

The decoder portion of the network flattens the output of the feature extractor and comprises two fully connected layers with ReLu activation and a dropout layer disposed between the fully connected layers for regularization. A sigmoid activation function and thresholding are carried out as well.

The appropriately configured convolutional neural network can be achieved by using validation and early termination upon observation of the validation loss. The loss function used can be configured as a binary cross-entropy. The optimizer used can be an Adam optimizer with a learning rate of 0.0005, for instance.

The appropriately configured convolutional neural network can be achieved by executing 100 epochs, for example. The correspondingly used training data set 400 can include 1125 image representations 321, for example, wherein the image representations 321 represent 334 intersections 319 and 582 roundabouts 315.

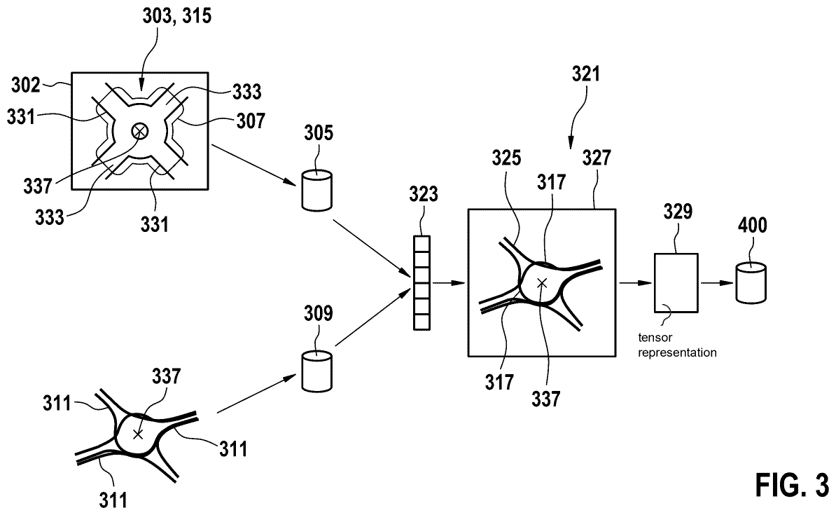

FIG. 3 shows a schematic illustration of method steps of a method 200 for generating a training data set 400 for training a classifier module 313 for classifying a traffic junction 303 according to one embodiment.

In the shown embodiment, the depicted method for generating a training data set 400 for training a corresponding classifier module 313 for classifying a traffic junction 303 is based on the steps of method 100 for generating a road map 300 with classification information 301 in the embodiment of FIG. 2.

To generate the training data set 400, the method steps up to generating the tensor representation 329, which have been described above in detail with respect to FIG. 2, are executed.

To generate the training data set 400, the tensor representations 329 generated for different traffic junctions 303 are combined into a corresponding training data set 400. For this purpose, the tensor representations 329 can be grouped for training and testing the classifier module 313 as is common practice in the related art.

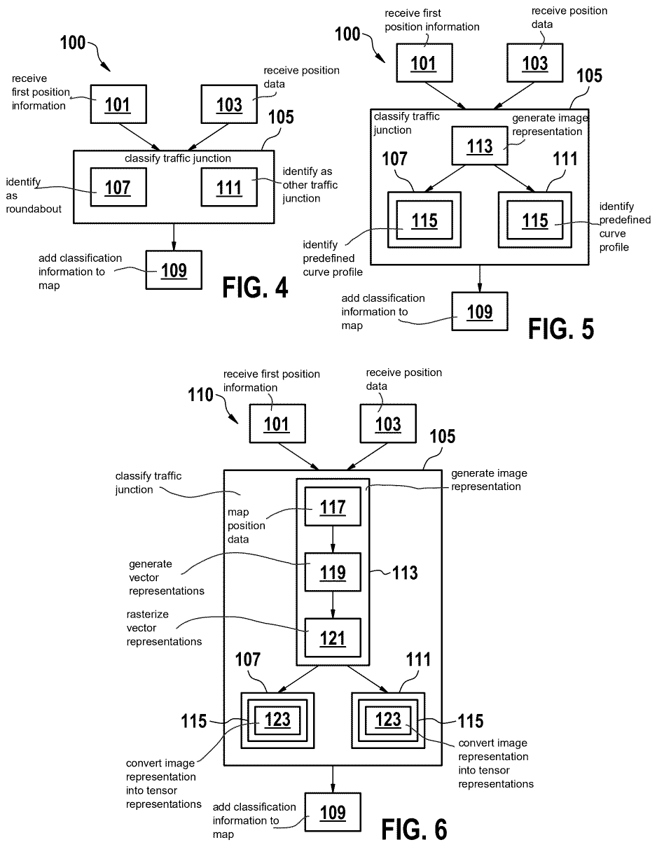

FIG. 4 shows a flow chart of the method 100 for generating an electronic road map 300 with classification information 301 for a traffic junction 303 according to one embodiment.

To generate the electronic road map 300 with classification information 301 for the traffic junction 303, first position information of the spatial region 307 of the electronic road map 302 that includes the traffic junction 303 is received in a first method step 101.

In a further method step 103, the position data 309 from the plurality of vehicles driving through the traffic junction 303 are received. The position data 309 describe the position histories 311 of the vehicles as they drove through the traffic junction 303.

In a further method step 105, the traffic junction 303 is classified by the classifier module 313 based on the position information 305 and the position data 309.

For this purpose, in a method step 107, the traffic junction 303 is identified as a roundabout 315 if at least a predefined number of position histories 311 in the plurality of position histories 311 of the vehicles exhibit a predefined curve profile 317.

In a method step 111, the traffic junction 303 is identified as one from the following list: intersection, junction, on-ramp onto a country road, federal highway or freeway, off-ramp from a country road, federal highway or freeway, highway interchange, if less than the predefined number of position histories 311 in the plurality of position histories 311 exhibit the predefined curve profile 317.

In another method step 109, classification information 301 for the traffic junction 303 is added to the electronic road map 302 and used to generate the electronic road map 302 with classification information 301.

FIG. 5 shows a further flow chart of the method 100 for generating an electronic road map 300 with classification information 301 for a traffic junction 303 according to another embodiment.

The embodiment shown in FIG. 5 is based on the embodiment in FIG. 4 and comprises all of the method steps described there.

In the shown embodiment, classifying the traffic junction 303 comprises a method step 113. In method step 113, an image representation 321 of the traffic junction 303 is generated with the position histories 311 of the vehicles passing through it based on the position information 305 of the spatial region 307 of the traffic junction 303 and the position data 309 of the vehicles.

The method steps 107 and 111 also include the method step 115. In method step 115, the predefined curve profile 317 is identified in the position histories 311 of the vehicles based on the image representation 321.

FIG. 6 shows a further flow chart of the method 100 for generating an electronic road map 300 with classification information 301 for a traffic junction 303 according to another embodiment.

The embodiment shown in FIG. 6 is based on the embodiment in FIG. 5 and comprises all of the method steps described there.

In the shown embodiment, generating 113 the image representation 321 includes method step 117. In method step 117, the position data 309 of the position histories 311 of the vehicles are mapped to the position information 305 of the spatial region 307 of the traffic junction 303.

For this purpose, the position information 305 of the spatial region 307 that corresponds to the position data 309 of the respective position histories 311 of the vehicles is selected.

In a method step 119, vector representations 323 of the selected position information 305 of the spatial region 307 of the traffic junction 303 are generated.

In a further method step 121, the vector representations 323 are rasterized. For this purpose, the selected position information 305 of the spatial region 307 of the traffic junction 303 that represents the position histories 311 of the vehicles is mapped as contiguous line elements 325 on a predefined image surface 327.

In the shown embodiment, the method step 115 also comprises a method step 123. In method step 123, the image representation 321 is converted into tensor representations 329.

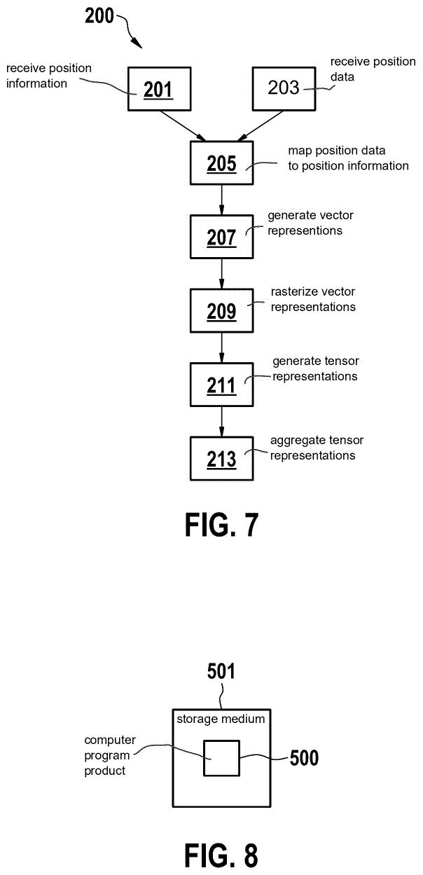

FIG. 7 shows a further flow chart of method 200 for generating a training data set 400 for training a classifier module 313 for classifying a traffic junction 303 according to one embodiment.

To generate the training data set 400 for training a classifier module 313 to carry out a classification of a traffic junction 303, first the position information of the spatial region 307 of the electronic road map 302 that includes the traffic junction 303 is received in a method step 201.

In a method step 203, the position data 309 from the plurality of vehicles driving through the traffic junction 303 are received.

In a method step 205, the position data 309 of the position histories 311 of the vehicles are mapped to the position information 305 of the spatial region 307 of the traffic junction 303.

For this purpose, the position information 305 of the spatial region 307 that corresponds to the position data 309 of the respective position histories 311 of the vehicles is selected.

In a method step 207, vector representations 323 of the selected position information 305 are generated.

In method step 209, the vector representations 323 are rasterized by mapping the selected position information 305 of the spatial region 307 that represents the position histories 311 as contiguous line elements on a predefined image surface.

In a method step 211, tensor representations 329 are generated from the correspondingly generated image representations 321 that were produced by the rasterization of the vector representations 323.

In a method step 213, the tensor representations are aggregated into the training data set 400.

FIG. 8 shows a schematic illustration of a computer program product 500 comprising instructions that, when the program is executed by a data processing unit, cause said data processing unit to carry out the method 100 for generating an electronic road map 300 with classification information 301 for a traffic junction 303 and/or the method 200 for generating a training data set 400 for training a classifier module 313 for classifying a traffic junction 303.

In the shown embodiment, the computer program product 500 is stored on a storage medium 501. The storage medium 501 can be any storage medium from the related art.

What is claimed is:

1. A method for generating an electronic road map with classification information for a traffic junction, the method comprising the following steps:
receiving position information of a spatial region of an electronic road map that includes the traffic junction;
receiving position data from a plurality of vehicles driving through the traffic junction, wherein the position data depict position histories of the plurality of vehicles as they drove through the traffic junction;
classifying the traffic junction using a classifier module based on the position information of the spatial region that includes the traffic junction and based on the position data from the plurality of vehicles driving through the traffic junction, wherein the classifying includes identifying the traffic junction as a roundabout when at least a predefined number of position histories in the plurality of position histories exhibit a predefined curve profile;
adding classification information for the traffic junction to the electronic road map; and
generating the electronic road map with classification information.

2. The method according to claim 1, wherein the classifying includes, identifying, when less than the predefined number of position histories in the plurality of position histories exhibit the predefined curve profile, the traffic junction as one from the following list: intersection, junction, on-ramp onto a country road, federal highway or freeway, off-ramp from a country road, federal highway or freeway, highway interchange.

3. The method according to claim 1 wherein the predefined curve profile has a profile from the following list: quarter-circular profile, semicircular profile, three-quarter circular profile, circular profile.

4. The method according to claim 1, wherein the predefined curve profile includes a predefined angular range, and wherein the predefined angular range is an angle from the following list: at least 90°, at least 180°, at least 270°, at least 360°.

5. The method according to claim 1, wherein the predefined curve profile has a predefined curve radius.

6. The method according to claim 1, wherein the classifying further includes:
generating an image representation of the traffic junction with the position histories of the vehicles passing through it based on the position information of the spatial region of the traffic junction and the position data of the vehicles, wherein the identifying includes: recognizing the predefined curve profile in the position histories of the vehicles.

7. The method according to claim 6, wherein the generating of the image representation includes:
carrying out a mapping of the position data of the position histories of the vehicles to the position information of the spatial region of the traffic junction by selecting the position information of the spatial region that corresponds to the position data of the respective position histories of the vehicles;
generating vector representations of the selected position information of the spatial region of the traffic junction;
rasterizing the vector representations by mapping the selected position information of the spatial region of the traffic junction that represents the position histories as contiguous line elements on a predefined image surface, wherein the recognizing of the curve profiles includes converting the image representation into tensor representations.

8. The method according to claim 7, wherein the tensor representations are embodied as grayscale tensor representations.

9. The method according to claim 1, wherein the spatial region of the traffic junction of the electronic road map is shaped as a polygon and represents a spatial outline of road boundaries of roads converging at the traffic junction.

10. The method according to claim 1, wherein the classifier module includes at least one correspondingly trained convolutional neural network.

11. The method according to claim 1, wherein the position data of the plurality of vehicles are GPS trace data.

12. An electronic road map with classification information for a traffic junction, wherein the road map was generated by the following steps comprising:
receiving position information of a spatial region of an electronic road map that includes the traffic junction;
receiving position data from a plurality of vehicles driving through the traffic junction, wherein the position data depict position histories of the plurality of vehicles as they drove through the traffic junction;
classifying the traffic junction using a classifier module based on the position information of the spatial region that includes the traffic junction and based on the position data from the plurality of vehicles driving through the traffic junction, wherein the classifying includes identifying the traffic junction as a roundabout when at least a predefined number of position histories in the plurality of position histories exhibit a predefined curve profile;
adding classification information for the traffic junction to the electronic road map; and
generating the electronic road map with classification information.

13. A method for generating a training data set for training a classifier module to carry out a classification of a traffic junction to generate an electronic road map with classification information, the method comprising the following steps:
receiving position information of a spatial region of an electronic road map that includes a traffic junction;
receiving position data from a plurality of vehicles driving through the traffic junction, wherein the position data depict position histories of the plurality of vehicles as they drove through the traffic junction;
carrying out a mapping of the position data of the position histories of the plurality of vehicles to the position information of the spatial region of the traffic junction by selecting the position information of the spatial region that corresponds to the position data of the respective position histories of the plurality of vehicles;
generating vector representations of the selected position information of the spatial region of the traffic junction;
rasterizing the vector representations by mapping the selected position information of the spatial region of the traffic junction that represents the position histories as contiguous line elements on a predefined image surface;
generating tensor representations based on the image representation; and
aggregating the tensor representations into the training data set.

14. A training data set for training a classifier module for classifying a traffic junction, wherein the training data set was generated according to a method for generating the training data set, comprising the following steps:
receiving position information of a spatial region of an electronic road map that includes a traffic junction;
receiving position data from a plurality of vehicles driving through the traffic junction, wherein the position data depict position histories of the plurality of vehicles as they drove through the traffic junction;
carrying out a mapping of the position data of the position histories of the plurality of vehicles to the position information of the spatial region of the traffic junction by selecting the position information of the spatial region that corresponds to the position data of the respective position histories of the plurality of vehicles;
generating vector representations of the selected position information of the spatial region of the traffic junction;
rasterizing the vector representations by mapping the selected position information of the spatial region of the traffic junction that represents the position histories as contiguous line elements on a predefined image surface;
generating tensor representations based on the image representation; and
aggregating the tensor representations into the training data set.

15. A system comprising:
a computing unit configured to execute a method for generating an electronic road map, the method including the following steps:
receiving position information of a spatial region of an electronic road map that includes a traffic junction;
receiving position data from a plurality of vehicles driving through the traffic junction, wherein the position data depict position histories of the plurality of vehicles as they drove through the traffic junction;
classifying the traffic junction using a classifier module based on the position information of the spatial region that includes the traffic junction and based on the position data from the plurality of vehicles driving through the traffic junction, wherein the classifying includes identifying the traffic junction as a roundabout when at least a predefined number of position histories in the plurality of position histories exhibit a predefined curve profile;
adding classification information for the traffic junction to the electronic road map; and
generating the electronic road map with classification information.

16. A non-transitory computer-readable medium on which is stored a computer program including instructions for generating an electronic road map with classification information for a traffic junction, the instructions, when executed by a data processor, causing the data processor to perform the following steps comprising:
receiving position information of a spatial region of an electronic road map that includes the traffic junction;
receiving position data from a plurality of vehicles driving through the traffic junction, wherein the position data depict position histories of the plurality of vehicles as they drove through the traffic junction;
classifying the traffic junction using a classifier module based on the position information of the spatial region that includes the traffic junction and based on the position data from the plurality of vehicles driving through the traffic junction, wherein the classifying includes identifying the traffic junction as a roundabout when at least a predefined number of position histories in the plurality of position histories exhibit a predefined curve profile;
adding classification information for the traffic junction to the electronic road map; and
generating the electronic road map with classification information.
